(19) United States
(12) Patent Application Publication
(10) Pub. No.: US 2002/0112196 A1
(43) Pub. Date: Aug. 15, 2002

(54) Distributed processing and criteria-based dynamic modification of data-flow map

(76) Inventors: Utpal Datta, Bedford, NH (US); Kevin Farrell, Windham, NH (US); Timothy Landon, Bedford, NH (US); Jeffrey Rogers, Nashua, NH (US); Norbert Ghersin, Ottawa (CA)

Correspondence Address: DENIS G. MALONEY, Fish & Richardson P.C., 225 Franklin Street, Boston, MA, 02110-2804, US

(21) Appl. No.: 10/044,847

(22) Filed: Jan. 11, 2002

Related U.S. Application Data
(60) Provisional application No. 60/260,991, filed on Jan. 11, 2001.

(51) Int. Cl. H04L 1/22

(52) U.S. Cl. 714/4

(57) ABSTRACT

Fault management and recovery in a distributed network accounting system includes classifying nodes in the system according to complexity of processing in the node. For nodes of relatively low processing complexity, context check-pointing a state of processing in the nodes to permit automatic recovery of the node to the nodes' most recent processing context checkpoint; and for nodes of relatively high complexity, producing a directed graph of the programmable nodes that controls a flow of data and control of processing through the system, and producing a dynamic modification of the directed graph to automatically fail-over to redundant back-up nodes based on thresholds established for the component hosts.

This application claims the benefit of U.S. Provisional Patent Application Ser. No. 60/260,991 filed Jan. 11, 2001, entitled “ENHANCED ACCOUNTING MANAGEMENT SYSTEM” by Utpal Datta, et al.

### BACKGROUND

This invention relates to carrier-class, e.g., telecom switching and transmission, network accounting.

Service Accounting is a carrier-class mediation solution designed for multi-service, multi-vendor, wireless & IP network environments. By transforming network data into useful information representing a service-level view of customer activity, service providers can price, bundle, and discount in a way that significantly differentiates their service offerings. With carrier-class service accounting reliability and scalability are important considerations. Lost billing data represents lost revenue, making carrier-class reliability an important consideration.

### SUMMARY

According to the present invention, a method to process large volumes of data using many node hosts in a system includes producing a directed graph of the programmable nodes that guides the flow of data and control of processing from one node to the next node through the system.

According to an additional aspect of the present invention, a computer program product residing on a computer readable medium provides fault tolerance to processing nodes executing on host computers of a distributed network accounting system. The computer program product includes instructions for causing a computer to produce a directed graph of the programmable nodes that guides the flow of data and control of processing from one programmable node to the next programmable node through the system and form a dynamic modification of the data-flow map to automatically fail-over to redundant back-up programmable nodes based on thresholds established for the component hosts.

According to an additional aspect of the present invention, a distributed network accounting system includes a plurality of host computers that host a network accounting system, and a computer program product residing on a computer readable medium for providing fault tolerance to a data processing domain of the network accounting system. The computer program product includes instructions for causing the host computer to produce a directed graph of the programmable nodes that guides the flow of data and control of processing from one programmable node to the next programmable node through the system and form a dynamic modification of the data-flow map to automatically fail-over to redundant back-up programmable nodes based on thresholds established for the component hosts.

According to and additional aspect of the present invention, a method for recovery of processing in a distributed network accounting system comprising many nodes executing on node host is provided. The method includes classifying nodes in the system according to complexity of processing in the node. For nodes of relatively low processing complexity, the method context check-points a state of processing in the nodes to permit automatic recovery of the node to the nodes' most recent processing context checkpoint and for nodes of relatively high complexity, the method produces a directed graph of the programmable nodes that controls a flow of data and control of processing through the system, and producing a dynamic modification of the directed graph to automatically fail-over to redundant back-up nodes based on thresholds established for the component hosts.

One or more aspects of the invention may include one or more of the following advantages.

The invention provides a network service accounting system that is scalable, enabling rapid increases or decreases in capacity as business needs change and evolve. The invention also provides a solution that delivers extremely high availability, ensuring peak performance and full reliability under heavy loads. In addition, reliability measures can be easily implemented at the specific points they are required. For example, data redundancy can be achieved by multi-casting a single data stream destined for a billing system into multiple streams. This allows data to be directed to geographically dispersed, redundant databases or file servers that are backed up at regularly scheduled intervals. This approach can be implemented at any point in the mediation model, enabling service providers to establish reliability according to the specific needs of their networking environment.

The invention also provides a reliable accounting system that is scalable, enabling rapid increases or decreases in system capacity as business needs change and evolve. Each accounting node on a particular system is run under the control of a parent process. The parent process persistently maintains the current state of nodes in the system. The current state of nodes includes the process status (i.e. which components are running) and a list of usage data that has been successfully processed. In the event of a graceful or even non-graceful shutdown, the system state is preserved, and is used to restore the system back to its last known state. This allows the system to “remember” what it was doing at the time of termination, thus permitting the system to restart where it left off. This capability ensures that no usage data will be lost during a system shutdown. Thus, the system provides graceful restart capabilities so that if the system is shut down and/or restarted, each component can resume processing where it left off in a manner that ensures that a double-counting/processing does not take place.

The invention also provides a solution that delivers extremely high availability, ensuring peak performance and full reliability under heavy loads. In addition, reliability measures can be easily implemented at the specific points they are required. The invention can include component fail-over. That is, in the event that a downstream component fails, each component can switch to a local or remote backup component. The routing functionality of every component also enables reliability measures to be implemented at the specific points where it is required. For example, data redundancy can be achieved by multi-casting a single data stream into multiple streams. This allows data to be directed to geographically dispersed, redundant databases or file servers that are backed up at regularly scheduled intervals.

### BRIEF DESCRIPTION OF THE DRAWINGS

FIG. 1 is a block diagram of a network system including distributed data collection/processing system.

FIG. 2 is a block diagram depicting a logical view of a network accounting implementation using the distributed data collection/processing system of FIG. 1.

FIG. 3 is a block diagram of a data processing domain in the data collection/processing system of FIG. 1.

FIG. 4 is a chart showing queue assignments used for data flow management.

FIG. 5 is a block diagram showing data flow management maps.

FIG. 6 is a block diagram of data flow management in the system of FIG. 1.

FIG. 7 is a block diagram showing queue structures.

FIG. 8 is a block diagram of general node function processing.

FIG. 9 is a flow chart showing record transfer under the data flow management process.

FIG. 10 is a flow chart of processing for a fault manager.

FIG. 11 is a flow chart of processing for an operational status, e.g., health interface process on a fault manager.

FIG. 12 is a flow chart of processing in fault manager for downstream faults.

FIG. 13 is a flow chart showing check point processing in a recovery manager.

FIG. 14 is a block diagram of a programmable system that can be used as node hosts and other devices in the system of FIG. 1.

### DESCRIPTION

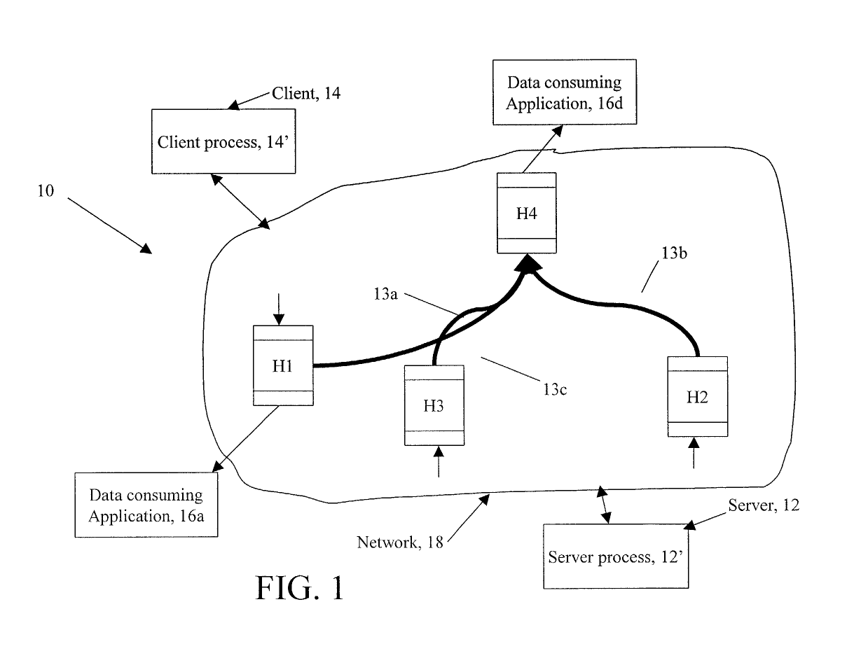

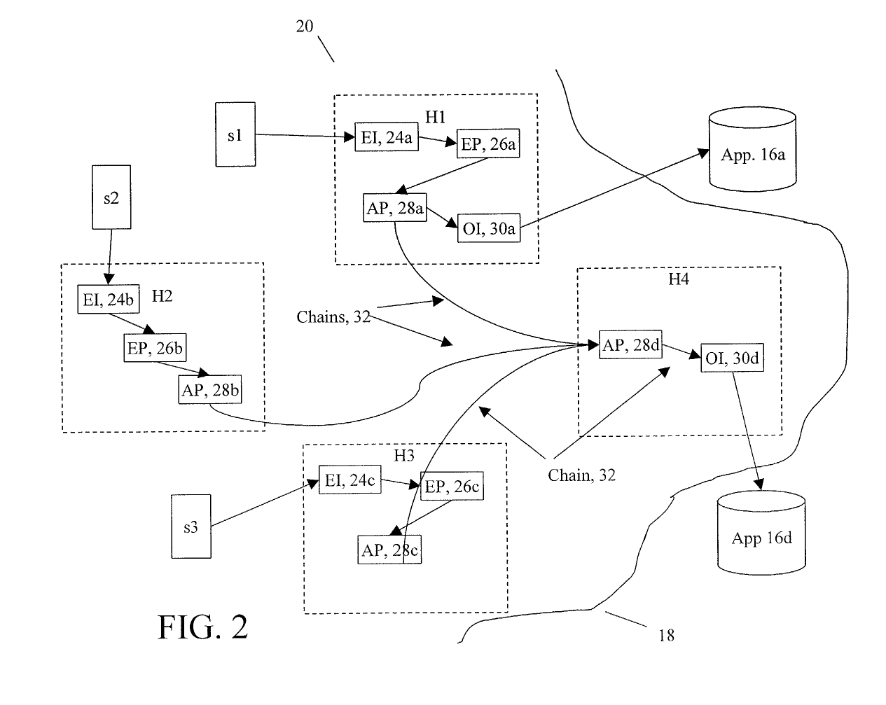

Referring to FIG. 1, an implementation of a distributed data collection system 10 is shown. The distributed data collection system 10 can be used to obtain network information for an accounting process or, alternatively, can be used for other data collection activity such as providing data to user-defined data consuming applications such as billing, performance reporting, service level management, capacity planning, trending, and so forth. Herein the system will be described with respect to an accounting process 20 (FIG. 2) although other implementations, of course, can be used.

The data collection system 10 includes a plurality of host computers H1-H4 dispersed across a network 18 such as the Internet. The host computers H1-H4 can be any computing device that includes a central processing unit or equivalent. The host computers H1-H4 are disposed in the network 18 in order to capture network data flowing through the network. The host computers H1-H4 include configurable nodes, as will be described, which are arranged to process the network data in a distributed manner. The host computers H1-H4 transfer records between each other via virtual paths 13a-13c using a network protocol. Thus, if the network is the Internet the Transport Control Protocol/Internet Protocol (TCP/IP) is used. As shown in FIG. 1, the system also includes a server computer, e.g., an administrative server 12 that runs a administrative server process 12′ used to configure nodes on the host computers H1-H4 in order to provide the desired data collection activity. The data collection system 10 also includes a client system, e.g., an administrative client 14 operating a administrative client process 14′ that interfaces with the administrative server process 12′ in order to accomplish the aforementioned configuration functions. As also shown, host systems H1 and H4 include interfaces (not numbered) that couple to user defined applications 16a, 16d such as billing, performance reporting, service level management, capacity planning, trending, and so forth.

In addition, host systems H1, H2 and H3 also include equipment interfaces (not numbered) that obtain data from the network 18. The network devices (not shown) can produce data of various types and formats that are handled in the data collection system 10. Examples of data types include “Remote Authentication Dial-In User Service” records (RADIUS). Other information sources can include network traffic flow, Remote Network Monitoring (RMON/RMON2 data), Simple Network Management Protocol.(SNMP)-based data, and other sources of network usage data. The host computers H1-H4 are configured and arranged in a manner to perform the specified function such as the network accounting function mentioned above. They can be geographically dispersed throughout the network but are logically coupled together in order to perform the requested task.

Referring now to FIG. 2, a logical view of the arrangement of FIG. 1 configured as an accounting process 20 is shown. Here the host computers H1-H4 each have a plurality of nodes, e.g., nodes 24a-24c on hosts H1-H3 respectively, nodes 26a-26c on hosts H1-H3 respectively, nodes 28a-28d on hosts H1-H4 respectively, and nodes 30a and 30d on nodes H1 and H4 only. The nodes within the host computers H1-H4 are arranged to provide chains 32 to provide the accounting process 20 as a chaining arrangement. Nodes 24a-24c are equipment interface nodes that will be described below which are used to obtain network data from network devices s1-s3 disposed within the network. The network devices s1-s3 can be switches, routers, remote access concentrators, probes, flow probes, directory naming services and so forth. Nodes 30a and 30d are output interfaces as also will be described below which are used to interface the network accounting process 20 to the network consuming applications 16a and 16b.

The chaining arrangement provides processing that is scalable, programmable and distributed. The assignment of nodes to host computers is generally arbitrary. That is, the nodes can be placed on any one of the host computers H1-H4, on fewer host computers or more host computers. The chaining of the nodes provides a data flow architecture in which input data/records are fed to the first node in the chain and the output records/data from the nodes are received from the last node of the chain. The data that is processed by each node is processed in an order in which nodes are arranged in the chain. The chain may be split into two or more chains or converge to fewer chains to accomplish different processing tasks or loads. This approach allows related network data that may be transient in terms of space and time to be received from disparate sources and processed in a timely and optimal fashion through parallel computation on multiple network computers to provide scalability.

Node types that may be included in an accounting process 20 include an Equipment Interface (EI) type such as nodes 24a-24c that collect data from a source outside the accounting process 10. In one embodiment the EI node translates data into network records, such as network accounting records (NARS). Network accounting records NARS are normalized network records. Since the accounting process 20 collects data from multiple types of network equipment, the EI node translates and normalizes these different types of records into a NAR. The NAR can be processed by any other node in the accounting process 20. There are several different specific EIs, one for each type of information source (i.e., RADIUS EI, GGSN EI, etc.)

The accounting process 20 also includes an enhancement processor node type (EP) e.g., nodes 26a-26c, which can perform several different processing tasks. The enhancement node may add attributes to a NAR based on the value of an existing attribute in the NAR. In addition, an enhancement node may perform filtering, data normalization, or other functions. The accounting process 20 also includes an aggregation processor node type (AP) e.g., nodes 28a-28d that aggregate a series of NARS into one NAR by correlating or as appropriate combining specific attributes and accumulating metrics over time. The system also includes an output interface node type (OI) e.g., nodes 30a and 30d that translates NARS to an external data format and delivers the data to a data consuming application. Additional details on the node processing types will be described below.

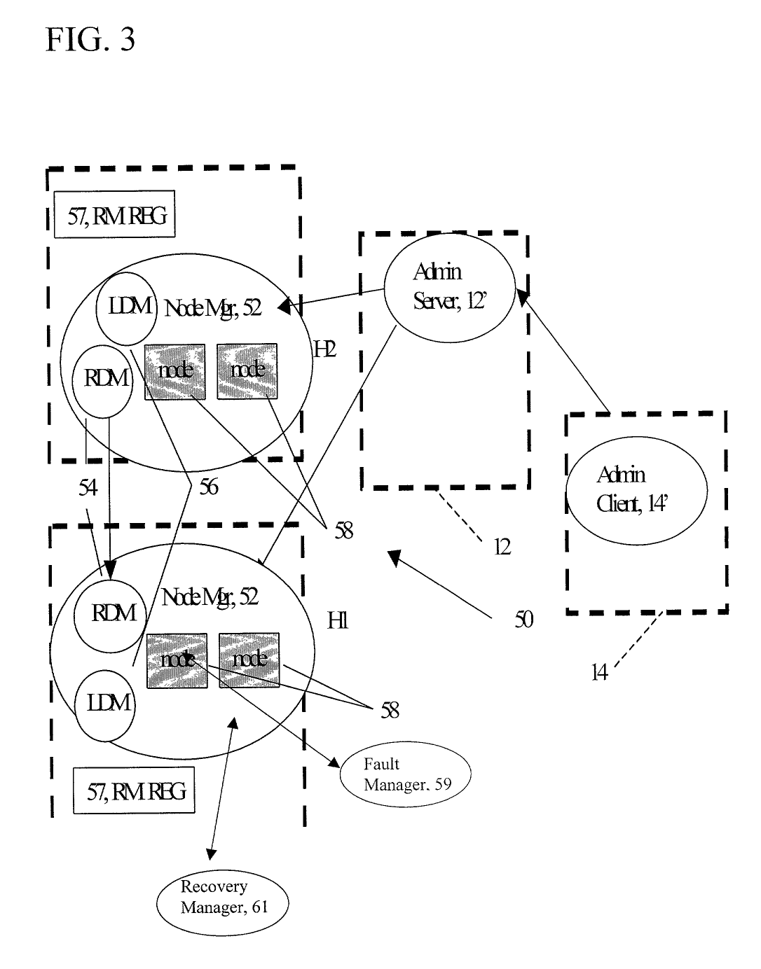

Referring to FIG. 3, a data processing domain 50 for nodes in the data collection system 10 such as the accounting process 20 includes run-time components. The run-time components include an administration Server (AS) 12′ executing on the administrative server 12 (FIG. 1) that provides communications between an Administration Client 14′ executing on the administrative client system 14 (FIG. 1) and Node Managers 52. A node manager 52 resides on each machine or host H1-H4 in the accounting process. The Admin Client (AC) 14′ is a browser applet or application or other process that allows a user to administer the accounting process 20 by supplying configuration information to the node managers 52. The Node Manager 52 provides a Remote Method Invocation (RMI) registry 57 on a well-known port, e.g., a port that is specified and registers itself in the RMI registry 57.

The Node Managers (NM) 52 manage nodes generally 58 e.g., nodes 24a-24c, 26a-26c, 28a-28d and 30a, 30d (FIGS. 2 and 3) that perform processing on data, records, and so forth. The accounting process 20 also includes a Local Data Manager (LDM) 56 that moves data i.e., network records such as NARS, between local nodes (i.e., nodes on the same host system), and Remote Data Manager (RDM) 54 that moves data between remote nodes (i.e., nodes on different host systems). In the accounting process 20, the accounting data or records are contained in queues. The data could also be contained in a file structure or other arrangements. The data processing domain 50 also includes a fault manager 59 that manages dynamic modification of data flow through the system 10 for processing nodes. The data processing domain can also include a recovery manager 61 that manages recovery of the data processing domain or any of the individual components of the data processing domain 50.

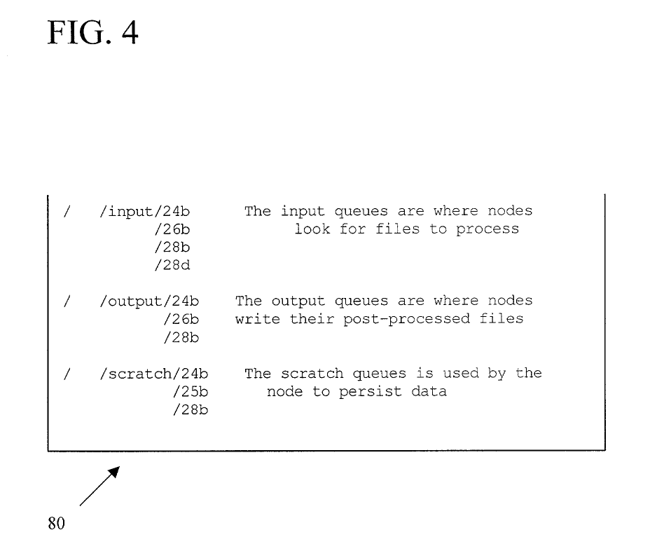

Referring to FIG. 4, an exemplary queue assignment 80 used for Data Flow on host H2 in FIG. 2 is shown. For the arrangement in FIG. 2, aggregation node 28d has an input queue on host H1 (FIG. 2), since it receives data from node 28a, which exists on host H1 (FIG. 2). Node 28d also has input queues on hosts H2 and H3 as well. Node 28d has input, output, and temporary queues on host H4 (FIG. 2).

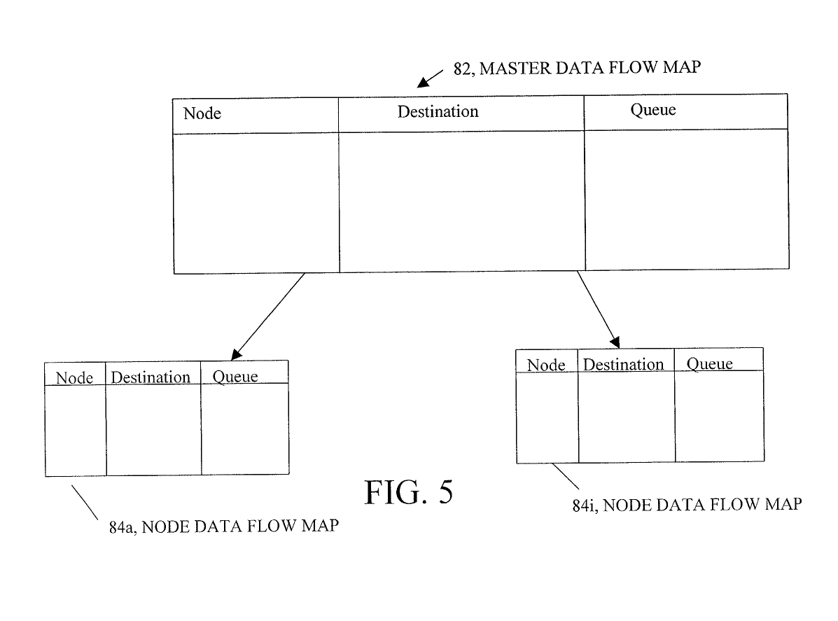

Referring to FIG. 5, data in accounting process 20 flows through the system 10 according to a Data Flow Map. The Admin Server 12 maintains a master or global Data Flow Map 82 for the entire accounting process 20. Each Node Manager maintains a subset of the master map, e.g., a local data flow map 84a-84i that maps only the portion of the node chain on the Node Manager's host. The data flow map is a data structure that lists all nodes that send data to other nodes to represent the flow of data. The Data Flow Map specifies, for each node, what nodes should receive output NARS from the node. Each node on a host has an input queue, and output queue, and a temporary queue on that host. Further, if a remote node does not exist on a particular host, but receives output from a node that does exist on the particular host, then the remote node has only an input queue on that host.

The node makes a decision as to which of downstream nodes a particular NAR will be delivered. That decision determines the input queue that the NAR is written to. Data managers 56 or 58 are responsible for moving data between nodes. The data manager 54 or 56 periodically (which is also configurable), looks to see what data is in output queues. When the data manager finds NARS the data manager moves the NARS to the appropriate input queue of a succeeding node. While this embodiment uses local and remote data managers, a single data manager that handles both local and remote transfers can be used.

Other distribution methods can be used. Thus, instead of nodes having a single output queues, nodes can have multiple queues. Multiple output queues provide the ability to split the NAR stream up into portions that can be delivered to different downstream nodes based upon selectable criteria.

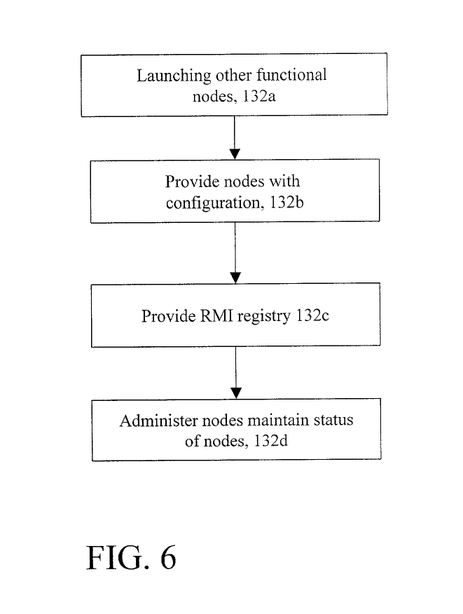

Referring to FIG. 6, processing by the Node Manager (NM) 52 (FIG. 5) that is included on each host that participates in an accounting process is shown. The Node Manager 52 is run at boot up time, and is responsible for launching 132a other functional processes (Nodes, LDM, RDM). During node initialization, the Node Manager 52 provides 132b nodes with all queue and configuration information that nodes require to run. Since a node exists as an object within the Node Manager 52, the NM 52 issues commands to the node as needed. The set of commands the Node Manager 52 may issue is defined in an interface that all nodes implement. It is also responsible for providing necessary data to the other components. All nodes, and the LDM/RDM exist in memory as objects maintained by the Node Manager.

The Node Manager 52 on each Accounting process provides 132c a Remote Method Invocation (RMI) registry 57 on a well-known port, e.g., a port that is specified and registers itself in the RMI registry 57. When produced by the Node Manager, an RDM 52 will also register itself in the registry 57 as part of its initialization processing. The node manager maintains the RMI registry 57 for the other processes, e.g., RDM, Admin Server, and acts as an entry point for all admin communications on its system.

The node manager 52 interfaces 132d with the Admin Server 12 and is responsible for adding, deleting, starting, stopping, and configure nodes, as requested by the Admin Server 12. The Node Manager 52 also maintains current status of all nodes and transfers that information to the Admin Server and maintains configuration information for components. The Admin Server communicates to the NM 52 by looking for the NM's registry 57 on the well-known port, and getting the reference to the NM 52 through the registry 57. The RDM 52 exists as a remote object contained within the Node Manager and registers itself in the registry 57 so that RDMs 52 on other node hosts can communicate with it via RMI 57.

As part of the initialization, the Node Manager 52 has two configuration files that are read in upon start up. The data flow map file indicates where the output of each node on the NM's computer should be directed. The output of some nodes on a given host may be directed to target nodes that are remote to the host. This file also contains the hostname or IP address of the host where the remote node is located. The node list file contains information about which nodes should be running on the NM's host, including the nodes' types, id numbers, and configured state (running, stopped, etc.) The NM 52 monitors all of the nodes, as well as the LDM and RDM. It receives events fired from each of these objects and propagates the events to the Admin Server. In addition, the node manager logs status received from the LDM/RDM and nodes.

As part of the NM administration 132d, the node manager administers changes to the data flow map and the node table. If either file is changed, the NM will cause the LDM, or RDM (depending on which file is changed) to reconfigure. The NM will write the node configuration file when a node is produced or node configuration is edited. If the node is running at the time, the NM will notify the node to reconfigure. The LDM moves the data from the output queues of producer nodes to the input queues of each node's consumers. When initialized, the LDM reads the local data flow map file and builds a data structure representing the nodes and destinations. The node manager periodically scans each source node's output queue. If the node manager discovers NARS in a node's output queue, the node manager copies the NARS to the input queues of the nodes that are destinations to that source node. Once the NAR has been fully distributed, the copy in the source node's output queue will be removed (deleted). If the LDM was unable to copy the NAR to all of it's destinations input queues, it will not remove the NAR but will keep attempting to send the NAR until it has been successfully transferred, at which time it will remove the file from the queue. The LDM reads only one “configuration” file at start up, the local data flow map file. This file contains a list of all of the nodes that the LDM services and the destinations of all of the nodes.

For nodes that reside on a remote host, a ‘local’ input queue is produced. NARS are copied to this local input queue as for local destination nodes. The RDM is responsible for moving NARS in these local input queues to the input queues of nodes on remote hosts. The RDM scans the input queues of nodes that are remote to the host the RDM is running on. If the RDM finds NARS, it connects to the RDM on the remote host that the destination node is on, transfers the NARS, and deletes the NARS.

Upon execution, the RDM registers in an RMI registry running on its local machine, on a well-known port. After registering itself in the RMI registry, the RDM reads in its remote data flow map file, which is maintained by the Node Manager. Based upon the mapping in the file, the RDM scans each remote node's local input queue. If it discovers NARS in an input queue, it connects to the RDM on the host that the remote destination node lives on, transfers the NARS, and then deletes the NARS. Once the NAR file has been fully distributed to all mapped remote nodes, the copy in the node's local input queue will be removed (deleted). If the RDM was unable to transfer the file to all of it's destination RDMs, it will not remove it. When an RDM is a, receiving a file, it first writes the data to a temporary file in its temporary area. After the file has been fully received and written, the RDM renames (moves) the file to the destination node's input area. This is to prevent a possible race condition that could occur if the node tries to read the file before the RDM is finished writing it to the input queue. The RDM reads only one “configuration” file at start up, the remote data flow mapping file. This file contains a list of all of the remote nodes that the RDM services, including their host IP addresses and RMI registry ports. The Node Manager List contains an entry for each node manager in the system. Each entry contains an IP address of the host that the NM's is on, it's RMI registry port, and it's name. The node list is a file that contains information on each node in the system.

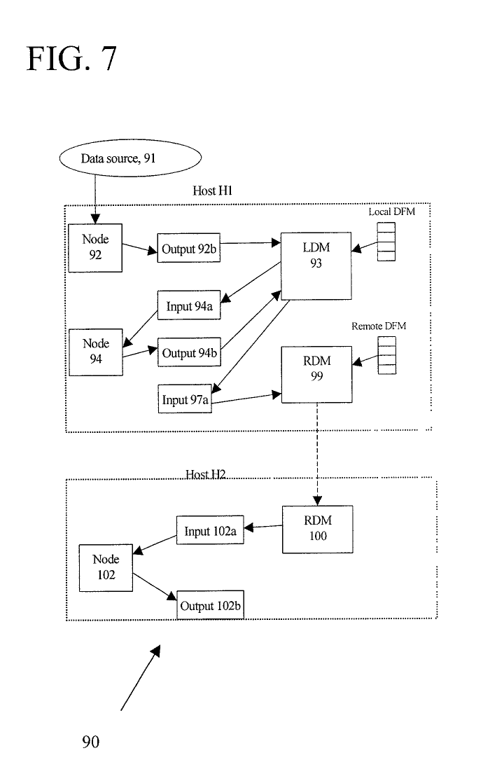

Referring to FIG. 7, a data flow example 90 in accounting process 20 is shown. The arrows indicate the directions that NARS are transferred. Data are received from a data source 91 at Node 92, an EI node. The EI node 92 converts the data to NARS, and writes the NARS to its output queue 92b. The LDM 93 moves the NARS from output queue 92b to an input queue 94a of node 94, in accordance with the Data Flow Map (DFM) for that LDM 93. Node 94 reads from its input queue 94a and writes to its output queue 94b. The LDM 93 moves the NARS from the output queue 94b to an input queue 97a. The RDM 99 reads the NARS from input queue 97a, connects with the RDM 100 on host H2, and sends the NARS to the RDM 100. The RDM 100 on host H2 receives the NARS, and writes them into input queue 102a. Node 102 on host H2 reads from its input queue 102a processes the NARS and writes NARS to output queue 102b. Nodes generally get input NARS from an input queue, and write output NARS to an output queue. The exceptions are E1s, which get input data from outside the accounting process 20, and OIs, which output data to data consuming applications that are outside the accounting process 20.

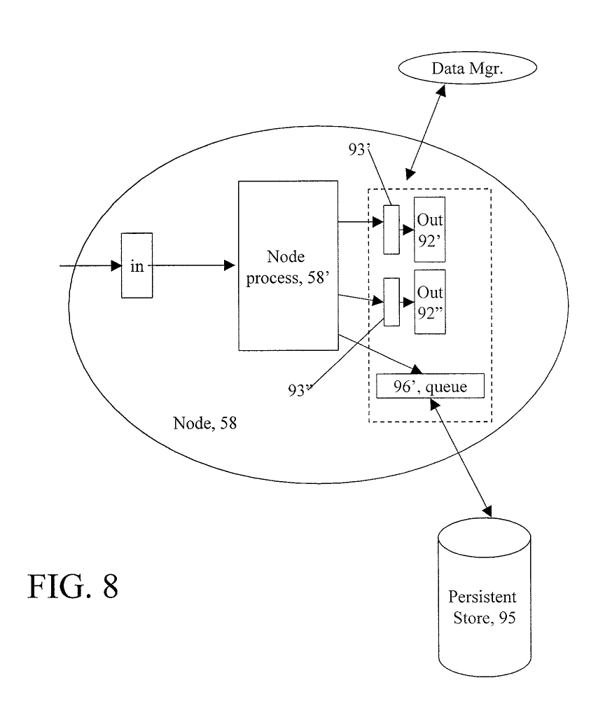

Referring to FIG. 8, generally a processing node 58 has a functional process 58′ (e.g., enhancing, aggregating, equipment interface or output interface, and others) and can use temporary queues 93′-93″ to keep a NAR “cache.” NAR cache can be used to hold output NARS, until the NARS are ready to be moved to the node output queue 92′, 92″. Once a node's current output cache grows to a configured size, the output file is placed in the output queue. Also, if the cache file has existed longer than a configured amount of time, the data manager node will move it to the output queue regardless of it's size. The data manager can be a LDM or a RDM. This will ensure that data continues to flow through the system in times of very low traffic. A queue 96′ can also be provided to hold NARS to persist to storage 95.

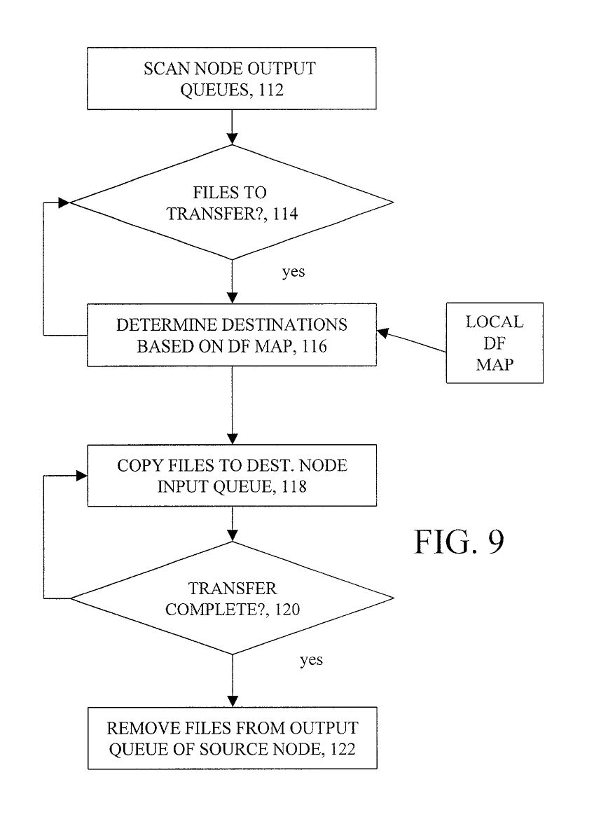

Referring to FIG. 9, the Local Data Manager LDM 93 distributes the NARS from each node's output queue to the destination node's input queues. There is one LDM 93 running on each node host in an accounting process 20. The LDM 93 periodically scans 112 node output queues, and determines 114 if there are NARS to transfer. If there are NARS to transfer the LDM determines 116 destinations based upon the local data flow mapping, and copies 118 NARS in the output queue to the destination node(s') input queue(s). Once the file is successfully distributed 120, the LDM removes 122 the file(s) from the output queue. In FIG. 5, on host H1, the LDM 93 would copy NARS from output 92b to input 94a, and from output 94b to input 97a. Even though node 102 is remote to host H1, node 102 still has an input queue on host H1 because node 102 receives input from a node on host H1.

The Remote Data Manager (RDM) 99 delivers NARS destined for nodes on remote hosts in generally the same manner as shown in FIG. 5B for the LDM. There is one RDM 99 running one each node host computer in an accounting process 20. The RDM periodically scans the input queues of remote nodes for NARS, transferring NARS by connecting to the RDM 100 on the destination machine and once a NAR has been successfully delivered, removing the NAR from the input queue. The accounting process 20 can also be configured to maintain NAR files after processing for backup and restore purposes. The RDM 100 also receives NARS from remote RDMs, and places them in the destination node's input queue. In FIG. 5, on node host H1, the RDM 99 would periodically check input queue 97a for NARS. Once found, it would open a connection to host H2, send the file, and remove the file from input 97a. The RDM 100 on host H2 would place the file in input queue 102a on host H2.

The accounting system 10 has a 1 to N level Redundancy of critical components and automatic recovery (to the most recent Context Check-point) of remaining components. Additional system resources are provided in proportion to the required level of redundancy. The system 10 includes a combination of several techniques to match the data loss, system up time and cost criteria provided by the customer. Such techniques can include distributed modular processing of data to reduce the chances of “Single Point of Failure,” store and forward of data at each node, backup and restore of data at each system node, and multicasting of data to redundant node chain.

Additional techniques include automatic fail-over to redundant back-up component based on operational status, e.g., “Health” and “Performance” thresholds of components and component hosts, and component context check-pointing and automatic recovery of components to the most recent context check-point.

Through the fault manager nodes 59 the system 10 provides back up and restore capability of the input storage of each type of node. The Data-Flow Map, and hence the control of data processing location and sequence, can be statically or dynamically changed. Data-Flow map can be statically configured to direct a copy of parts of a NAR stream to N downstream nodes based on the value(s) of one or more attributes within the incoming NAR. Thus, through the fault manager nodes, the Data-Flow Map can be dynamically modified to re-route the entire incoming NAR stream to a different (back-up) node if the “Health” or “Performance” level of the receiving node goes below a configurable threshold. This provides the dynamic fail-over capability of critical EAM components (the nodes).

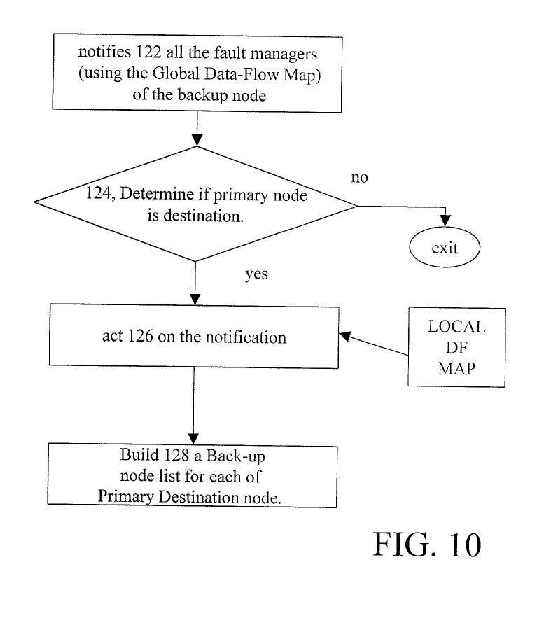

Referring to FIG. 10, processing 120 for the fault manager 59 is shown. Each node host runs the fault manager 59 along with the node manager 52. The Fault Manager 59 and the Node Manager 52 share the global Node-Map and the Local Node-Map. Each time a back-up node is provided for a primary node, the fault manager 59 notifies 122 all the fault managers (using the Global Data-Flow Map) of the backup node. The node-ids of the Primary node and the Back-up node are included in the notification. The node-id includes the destination IP-Address of its node host and the listen-port. The fault managers determine 124 if the Primary node is the destination node of one of the nodes running on its node host. If the primary node is one of the destinations, the fault manager in the node will act 126 on the notification. Otherwise the fault manager ignores the notification. The fault manager builds 128 a Back-up node list for each of its Primary Destination node.

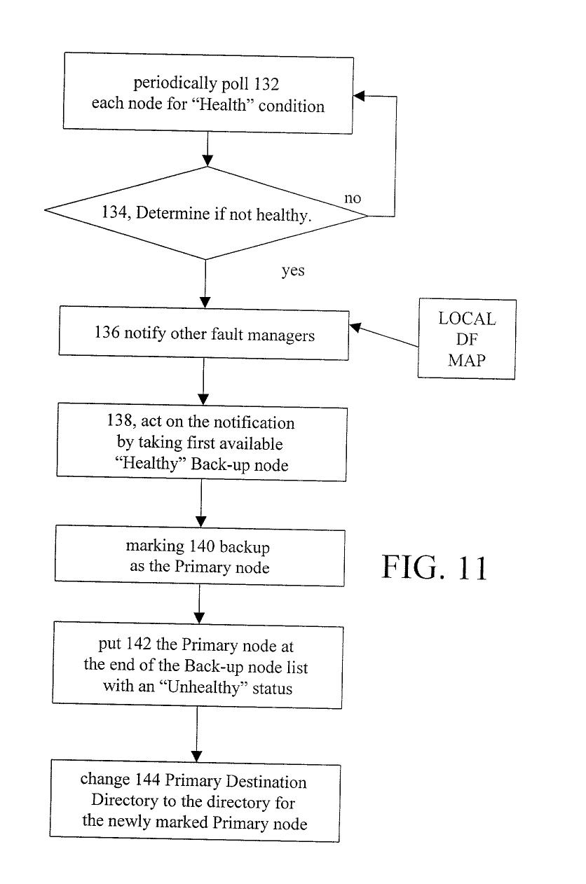

Referring to FIG. 11, the fault manager 59 in each node supports an “Is Healthy” interface. The Health interface measures include information on if all the threads running in the node, if the node is receiving enough CPU time, has enough disk space available and so forth. The fault manager periodically polls 132 each node on its node host for its “Health” condition using the “IsHealthy” interface. Node Manager also monitors the “Performance” levels of each node on the node host. “Performance” measures include how many NARs per second are being processed, how much free memory is available, how much free disk space is available. NM shares these “Performance” measures with the fault manager.

The Local Data Manager/Remote Data Manager always write the node's output to the Primary Destination Directory without any consideration on whether this directory name has changed or not. If the “Health” measure of a node goes 134 below a set threshold, fault manager notifies 136 all other fault managers. The fault managers act on the notification by taking 138 the first available “Healthy” Back-up node and marking 140 it as the Primary node. The fault manager puts 142 the Primary node at the end of the Back-up node list with an “Unhealthy” status. The fault manager changes 144 the Primary Destination Directory to the directory for the newly marked Primary node. Thus, effectively fault manager 59 dynamically changes the flow of data from an “Unhealthy” node to its “Healthy” Back-up node without affecting the working of any other part of the system. The system 10 continues to function normally. The same situation can continue N times for each of the M nodes of the node chain without data loss or system down time.

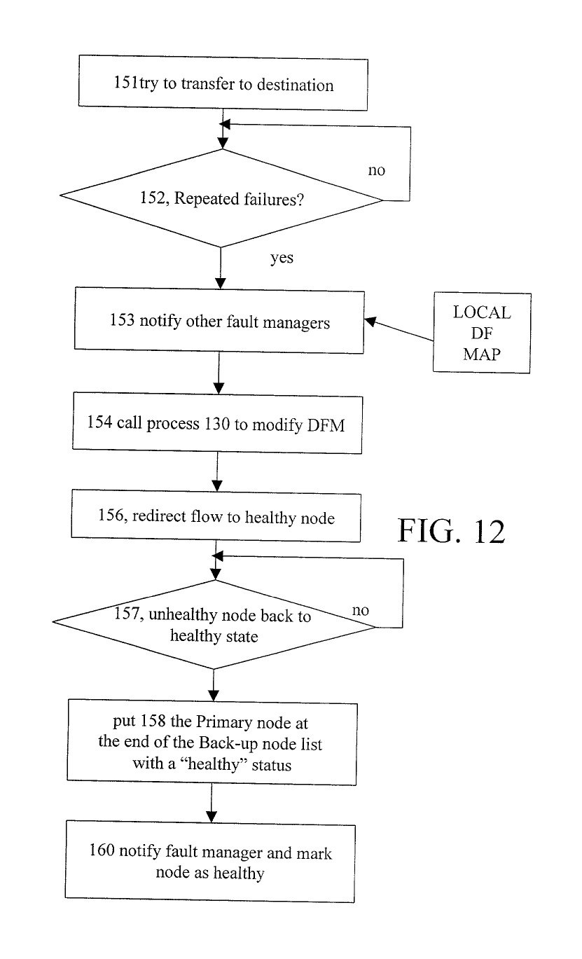

Referring to FIG. 12 in case the node host of a destination node goes down or the communication link between the source and the destination nodes go down, LDM/RDM unsuccessfully tries 151 to transfer the data to the destination node a configurable number of times. In case of repeated failures 152 it informs 153 fault manager indicating the destination (Primary) node as a non-operational, e.g., “Unhealthy” status. The fault manager goes through the procedure 130 above to dynamically modify 154 the Data-Flow Map and re-direct 156 the flow of data to a “Healthy” Back-up node for the “Unhealthy” Primary node and the system continues functioning without any data loss or any System Down-time. When the “Unhealthy” node comes back to normal running state 158, all the fault managers get notified 160. The fault managers, which have this node in its Back-up node list simply mark the node as “Healthy” and available. It should be noted that fault manager can be triggered to take the same fail-over actions if a node or a node host “Performance” level goes below a set threshold.

The system has automatic fail-over to redundant back-up of components based on “Health” and “Performance” thresholds of nodes and node hosts. The system uses the technique of dynamic modification of its Data-Flow Map based on the failure criteria set by the user. The failure criteria could be that the “Health” condition of a node has gone below some set threshold. It could also be that the “Performance level of a node or a set of nodes have gone below a set threshold because of lack of system resources (disk, memory, CPU availability etc.) on the node host. This provides fault tolerance to the system described above.

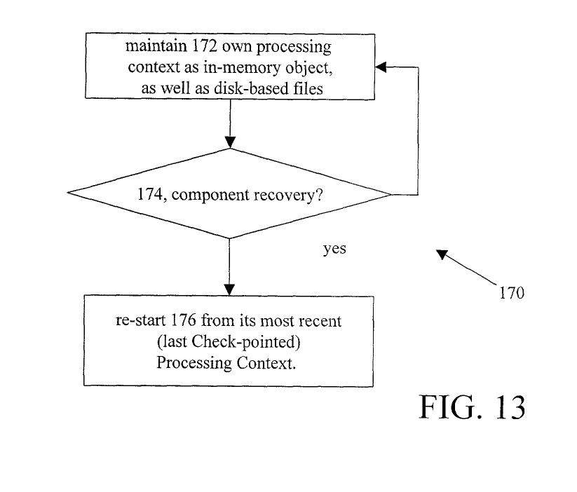

Referring to FIG. 13, the recovery manager 61 provides fault tolerance of components by context check-pointing and automatic recovery process 170 to the most recent processing context checkpoint. The system uses checking point technique in conjunction with operating system facilities to provide automatic recovery of the system components. Every component of the system 10 can, but does not need to have a 1 to N level redundancy, discussed above. Components such as node manager 52, local data manager 54, remote data manager 56, admin server and admin GUI or client, continually checkpoint their processing context. Fault tolerance process 170 has each component maintaining 172 its processing context as in-memory object, as well as persisted disk-based files. Thus, these files are all check-pointed. In case of failure and subsequent recovery 174 each system component can be re-started 176 from its most recent (last check-pointed) processing context.

Other than parts of the processing context of components, all the changes in the processing context of all the system 10 components are single/atomic transactions and hence are easily check-pointed. However, for a node, processing each NAR, writing it to the output file, updating of input and output NAR indices, and writing of new input and output NAR files (if required) are multiple steps that need to be done as a single atomic transaction.

Each system node and component has a processing context. Contents of the processing context vary from one node to another. For example, the processing context of a node includes the entries in its configuration file, its input NAR file name, input NAR index, output NAR file name and output NAR index. The processing context of the Admin Server includes its Node Manager Table, Global Node-Map etc. Processing context, such as the entries in the configuration files of nodes are relatively static and change only infrequently. Processing context, such as the Admin Server's Node Manager Table changes only when a Node Manager is added or deleted. Admin Server's Global Node-Map and each node manager's Local Node-Map changes when a node is added, removed from the Node-Map or the status of a node changes (from running to stopped etc). Whereas, processing context such as input NAR index and output NAR index changes with the processing and writing of each NAR.

In system 10 these components run as “Immortal” processes (under the management of “InetD” for Unix and as NT Services for NT). Thus the operating system automatically brings checkpointed components up if the checkpointed component should go down. Each of the components automatically re-starts from its most recent checkpoint state. The same automatic recovery technique could be used for nodes also, but since the node process context is relatively more complex to checkpoint, node fault tolerance is achieved through 1 to N level Redundancy described above.

Each accounting node on a particular system is run under the control of a parent process the “Node Manager.” This process persistently maintains the current state of the node in the system. The current state of the nodes in the system 10 includes the process status (i.e. which components are running) and a list of usage data that has been successfully processed. In the event of a graceful or even non-graceful shutdown, the system state is preserved, and is used to restore the system back to its last known state. This allows the system 10 to “remember” what it was doing at the time of termination, thus permitting the system 10 to restart where it left off. This capability ensures that no usage data will be lost during a system shutdown. Thus, the system provides graceful restart capabilities so that if the system is shut down and/or restarted, each component can resume processing where it left off in a manner that ensures that a double-counting/processing does not take place.

The system 10 can have components store copies of the records received for backup and restore purposes, enabling the data to be re-processed in the event of a downstream system failure. The system also has component fail-over. That is, in the event that a downstream component fails, each component can switch to a local or remote backup component. The routing functionality of every component also enables reliability measures to be implemented at the specific points where it is required. For example, data redundancy can be achieved by multi-casting a single data stream into multiple streams.

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

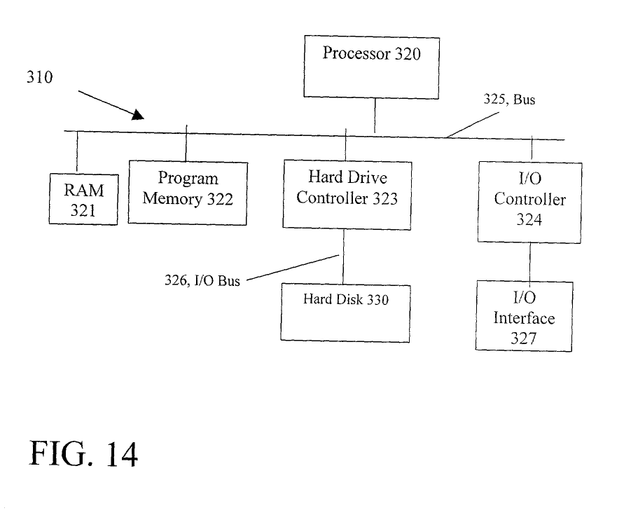

An example of one such type of computer is shown in FIG. 14, which shows a block diagram of a programmable processing system (system) 310 suitable for implementing or performing the apparatus or methods of the invention. The system 310 includes a processor 320, a random access memory (RAM) 321, a program memory 322 (for example, a writable read-only memory (ROM) such as a flash ROM), a hard drive controller 323, and an input/output (I/O) controller 324 coupled by a processor (CPU) bus 325. The system 310 can be preprogrammed, in ROM, for example, or it can be programmed (and reprogrammed) by loading a program from another source (for example, from a floppy disk, a CD-ROM, or another computer).

The hard drive controller 323 is coupled to a hard disk 330 suitable for storing executable computer programs, including programs embodying the present invention, and data including storage. The I/O controller 324 is coupled by means of an I/O bus 326 to an I/O interface 327. The I/O interface 327 receives and transmits data in analog or digital form over communication links such as a serial link, local area network, wireless link, and parallel link.

Other embodiments are within the scope of the appended claims.

What is claimed is:

1. A method to process large volumes of data using many node hosts in a system comprises:
producing a directed graph of the programmable nodes that guides the flow of data and control of processing from one node to the next node through the system.

2. The method of claim 1 further comprising:
forming a dynamic modification of the Data-Flow Map to automatically fail-over to redundant back-up nodes based on thresholds established for the component hosts.

3. The method of claim 2 wherein the system provides 1 to N level redundancy of nodes.

4. The method of claim 3 wherein each node includes a fault manager and node manager that share the data flow map and a subset of the data flow map.

5. The method of claim 3 wherein the fault manager provides a back-up node for a primary node.

6. The method of claim 4 wherein the fault manager that provides the backup node notifies all fault managers of other nodes by:
modifying the data flow map of the backup node.

7. The method of claim 6 wherein the notification includes the node-ids of the primary node and the back-up node and the node-id includes the destination IP-Address of its node host and a listen-port.

8. The method of claim 2 further comprising:
measuring information pertaining to operational status of a node by determining threads running in a node and processor resources provided to the node.

9. The method of claim 8 further comprising:
periodically polling each node on a node host for the node's operational status condition.

10. The method of claim 8 further comprising:
determining if a operational status measure of a node goes below a set threshold in order to notify other fault managers.

11. The method of claim 8 further comprising:
determining the first available healthy back-up node; and
marking the first available back-up node as the primary node, while placing the primary node at the end of a list with an non-operational status.

12. The method of claim 3 further comprising:
determining by a source node that a destination node cannot accept a transfer; and
indicating to the fault manager that the destination node is unhealthy to dynamically modify the data-flow map and re-direct the flow of data to a healthy back-up node for the unhealthy primary node.

13. A computer program product residing on a computer readable medium for providing fault tolerance to processing nodes executing on host computers of a distributed network accounting system, comprises instructions for causing a computer to:
produce a directed graph of the programmable nodes that guides the flow of data and control of processing from one programmable node to the next programmable node through the system; and
form a dynamic modification of the data-flow map to automatically fail-over to redundant back-up programmable nodes based on thresholds established for the component hosts.

14. The computer program product of claim 13 wherein the system provides 1 to N level redundancy of programmable nodes.

15. The computer program product of claim 13 wherein computer program product executes as a fault manager in a processing domain that includes a node manager, that manages execution of the programmable nodes that share the data flow map and a subset of the data flow map.

16. The computer program product of claim 14 wherein the fault manager establishes a back-up node for a primary node.

17. The computer program product of claim 16 wherein instructions to cause the fault manager to establish the backup node further comprises instructions to notify all fault managers of other nodes by instructions to:
modify the data flow map of the backup node.

18. The computer program product of claim 13 further comprising instructions to:
measure information pertaining to health of a node by determining threads running in a node and processor resources provided to the node.

19. The computer program product of claim 13 further comprising instructions to:
periodically poll each node on a node host for the node's health condition.

20. The computer program product of claim 15 further comprising instructions to:
determine if a health measure of a node goes below a set threshold in order to notify other fault managers.

21. The computer program product of claim 13 further comprising instructions to:
determine the first available healthy back-up node; and
mark the first available back-up node as the primary node, while placing the primary node at the end of a list with an unhealthy status.

22. The computer program product of claim 15 further comprising instructions to:
determine by a source node that a destination node cannot accept a transfer; and
indicate to the fault manager that the destination node is unhealthy to dynamically modify the data-flow map and re-direct the flow of data to a healthy back-up node for the unhealthy primary node.

23. A distributed network accounting system, comprising:
a plurality of host computers that host a network accounting system, and a computer program product residing on a computer readable medium for providing fault tolerance to a data processing domain of the network accounting system, comprises instructions for causing the host computer to:
produce a directed graph of the programmable nodes that guides the flow of data and control of processing from one programmable node to the next programmable node through the system; and
form a dynamic modification of the data-flow map to automatically fail-over to redundant back-up programmable nodes based on thresholds established for the component hosts.

24. The system of claim 23 wherein computer program product executes as a fault manager in a processing domain that includes a node manager, that manages execution of the programmable nodes that share the data flow map and a subset of the data flow map.

25. The system of claim 23 wherein the programmable nodes can be a data collector process that produces network accounting records, or an aggregation process that aggregates network accounting records, or an enhancement process that enhances attributes of network accounting records, or an output interface process that produces records for use by an application.

26. The system of claim 23 wherein the data processing domain further comprises:
a fault manager that executes the computer program to produce a dynamic modification of a directed graph.

27. The system of claim 23 wherein the computer program products executes on a component that is a node manager, a local data manager, a remote data manager, an administrative server or an administrative client.

28. The computer program product of claim 27 wherein the components that are nodes where changes in the processing context of the component are characterized as generally single/atomic transactions or other transactions the product further comprises instructions to:
context check-point a state of processing in the a data processing domain to permit automatic recovery of the data processing domain to the data processing domain's most recent processing context checkpoint; and
execute an operating system facility to provide the automatic recovery of the data processing domain to the data processing domain's most recent processing context.

29. The computer program product of claim 28 wherein the processing context of a component includes the entries in its configuration file or node manager table or global node-map.

30. A host computer for deployment in a distributed network accounting system, comprising:
a processor; and
a computer program product residing on a computer readable medium for providing fault tolerance to a network accounting process executed on the processor, comprises instructions for causing the processor to:
produce a directed graph of a group of programmable nodes that guides a flow of data and control of processing from one programmable node to the next programmable node through the distributed network accounting system; and
form a dynamic modification of the data-flow map to automatically fail-over to redundant back-up programmable nodes based on thresholds established for the component hosts.

31. The host computer of claim 31 wherein computer program product executes as a fault manager in the processing domain that includes a node manager, that manages execution of the programmable nodes that share the data flow map and a subset of the data flow map.

32. The host computer of claim 31 wherein the programmable nodes can be a data collector process that produces network accounting records, or an aggregation process that aggregates network accounting records, or an enhancement process that enhances attributes of network accounting records, or an output interface process that produces records for use by an application.

33. The host computer of claim 31 wherein the data processing domain further comprises:
a fault manager that executes the computer program to produce a dynamic modification of a directed graph.

34. A method for recovery of processing in a distributed network accounting system comprising many nodes executing on node hosts, the method comprises:
classifying nodes in the system according to complexity of processing in the node, and for nodes of relatively low processing complexity, context check-pointing a state of processing in the nodes to permit automatic recovery of the node to the nodes' most recent processing context checkpoint; and
for nodes of relatively high complexity, producing a directed graph of the programmable nodes that controls a flow of data and control of processing through the system, and producing a dynamic modification of the directed graph to automatically fail-over to redundant back-up nodes based on thresholds established for the component hosts.

35. The method of claim 34 wherein context check pointing provides 1 to 1 level of redundancy of node components.

36. The method of claim 34 wherein for nodes of relatively high complexity producing a directed graph provides 1 to N level redundancy of nodes.

37. The method of claim 34 wherein each component executes a recovery manager that provides fault tolerance of components by the context check pointing.

38. The method of claim 34 wherein the recovery manager uses operating system facilities to provide automatic recovery of the system components.
